(19) United States
(12) Patent Application Publication
(10) Pub. No.: US 2008/0295644 A1
(43) Pub. Date: Dec. 4, 2008

(54) Power transmission apparatus

(75) Inventors: Yoshiki Tada, Okazaki-city (JP); Michiyasu Nosaka, Anjo-city (JP); Hiromasa Tanaka, Ichinomiya-city (JP); Keiji Ishikawa, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/155,100

(22) Filed: May 29, 2008

(30) Foreign Application Priority Data
Jun. 1, 2007 (JP) 2007-146918

(51) Int. Cl. B23Q 16/00

(52) U.S. Cl. 74/826

(57) ABSTRACT

A power transmission apparatus including a rotary unit (10) rotated by receiving the turning effort and a nut member (3) for coupling the rotary unit (10) to a rotary shaft (4) of a rotary device is disclosed. The nut member (3) has a central hole (3e) formed therethrough from one end surface (3c) to the other end surface (3d) thereof and an internally threaded portion (3g) formed in the central hole (3e). The internally threaded portion (3g) is forced onto an externally threaded portion (4b) formed on the rotary shaft (4) from the other end surface (3d) side thereby to be screwed to the rotary shaft (4) while at the same time coupling the rotary unit (10) to the rotary shaft (4). The apparatus further includes a cap (5) fitted onto the nut member (3) in such a manner as to cover and seal one end surface (3c) of the nut member and an outer peripheral surface (3i) of the nut member connected to the peripheral edge of the one end surface (3c).

### BACKGROUND OF THE INVENTION

1. Field of the Invention

This invention relates to a power transmission apparatus for transmitting rotational force, or in particular, to a power transmission apparatus suitably used for a compressor of an air conditioning system of automobiles.

2. Description of the Related Art

A power transmission apparatus for transmitting power to the compressor, including a rotary unit having a belt pulley and a hub fastened to the rotary shaft of the compressor with a nut member, is described in, for example, Japanese Patent Application Publication No. 2007-127036. This conventional power transmission apparatus will be explained with reference to FIG. 4 showing a longitudinal sectional view of the essential parts thereof. Reference numeral 102 is a hub, numeral 103 a nut member (limiter unit), and numeral 104 a rotary shaft. The nut member 103 functions as a torque limiter having a fragile portion 103a, which is adapted to break to protect the belt, etc., at the time of seizure of the compressor under an excessively large torque. Oil or grease is coated on a threaded part T formed by screwing the rotary shaft 104 and the nut member 103 to each other in order to stabilize the operation of the torque limiter by maintaining a constant friction coefficient of threaded part T. For this purpose, a seal member 105 is disposed to prevent the intrusion of moisture and dust into threaded part T from outside, to suppress the outflow or evaporation of the oil or grease and further to prevent the corrosion of the forward end portion 104a of the rotary shaft. The seal member 105 is fitted, through a cylindrical fixing portion 105a, at the forward end portion 104a of the rotary shaft, and has a flange portion 105b adapted to come into contact with the end surface 103b of the nut member 103 thereby to seal the central hole 103c of the nut member 103.

Although the central hole 103c is sealed in this way, the seal member 105 only covers an externally exposed part of the end surface of the nut member 103, and therefore at least the portion of the nut member 103 not covered by the seal member 105 requires a surface treatment such as plating to prevent corrosion. However, in order to reduce the fabrication cost of the nut member, elimination of the surface treatment is desired.

### SUMMARY OF THE INVENTION

The present invention has been achieved in view of the problems of the prior art described above, and the object thereof is to provide a power transmission apparatus coupled by a nut member screwed to the rotary shaft of a rotary device and having a sealing structure for the screw portion, wherein the fabrication cost of the nut member is reduced.

This invention provides a power transmission apparatus described in each of the appended claims as a technical means for solving the problems described above.

According to a first aspect of the invention, there is provided a power transmission apparatus comprising a rotary unit (110) rotated by the turning effort received from a rotation drive source and a nut member (3) for coupling the rotary unit (10) to a rotary shaft (4) of the driven-side rotary device for transmitting the turning effort from the rotation drive source to the rotary device, wherein the nut member (3) includes a central hole (3e) formed through a second end surface (3d) from a first end surface (3c) of the nut member (3) and an internally threaded portion (3g) formed in the central hole (3e), and wherein the rotary unit (10) is coupled to the rotary shaft (4) by forcing the internally threaded portion (3g) onto an externally threaded portion (4b) on the rotary shaft (4) from the second end surface (3d) side, the power transmission apparatus further comprising a cap (5) capped on the nut member (3) in such a manner as to cover and seal the first end surface (3c) of the nut member (3) and an outer peripheral surface (3i) of the nut member (3) connected to the peripheral edge of the first end surface (3c).

With this configuration, not only the threaded portions (3g), (4b) for screwing the nut member (3) and the rotary shaft (4) to each other are sealed, but also the first end surface (3c) of the nut member (3) and the outer peripheral surface (3i) are effectively prevented from corrosion, thereby making it possible to use the nut member (3) without surface treatment, such as plating to prevent corrosion.

In the power transmission apparatus according to this invention, the cap (5) is suitably formed of an anti-corrosive material, a synthetic resin material or a rubber material.

According to another aspect of the invention, there is provided a power transmission apparatus, wherein the cap (5) includes an outer peripheral wall portion (5a) extending in axial direction and a bottom surface portion (5b) extending in radial direction in such a manner as to close the first end side of a space defined by the outer peripheral wall portion (5a), and wherein the bottom surface portion (5) may have a small hole (5c) as a vent. This configuration can prevent the cap (5) from coming off due to the increase in the internal pressure of the space of the central hole (3e) of the nut member (3), which is caused by on increase in temperature when the automobile is driven.

The reference numerals inserted into the parentheses following the names of the respective means described above indicate an example of correspondence with the specific means described in the embodiments below.

The present invention may be more fully understood from the description of preferred embodiments of the invention, as set forth below, together with the accompanying drawings.

### BRIEF DESCRIPTION OF THE DRAWINGS

FIG. 1 is a longitudinal sectional view of a power transmission apparatus according to an embodiment of the invention.

FIG. 2 is an enlarged view of the essential parts of the power transmission apparatus shown in FIG. 1.

FIG. 3 is a longitudinal sectional view of the essential parts of the power transmission apparatus according to a modification of an embodiment of the invention.

FIG. 4 is a longitudinal sectional view of the essential parts of the conventional power transmission apparatus.

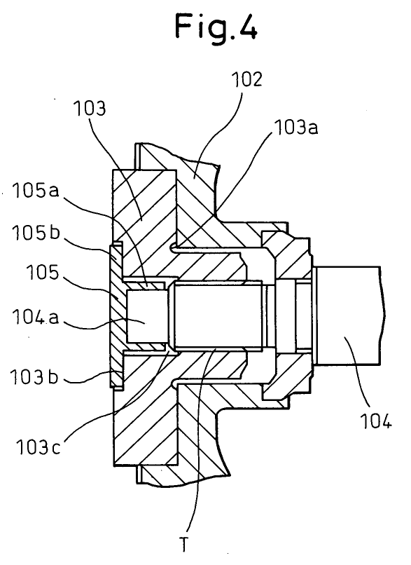

### DESCRIPTION OF THE PREFERRED EMBODIMENTS

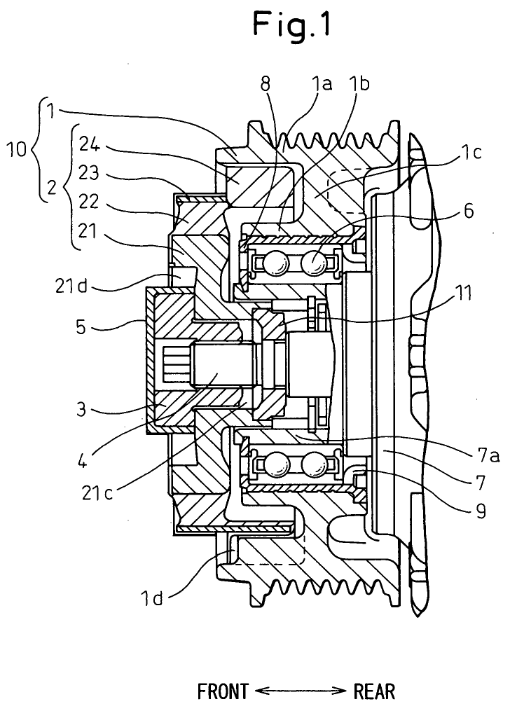

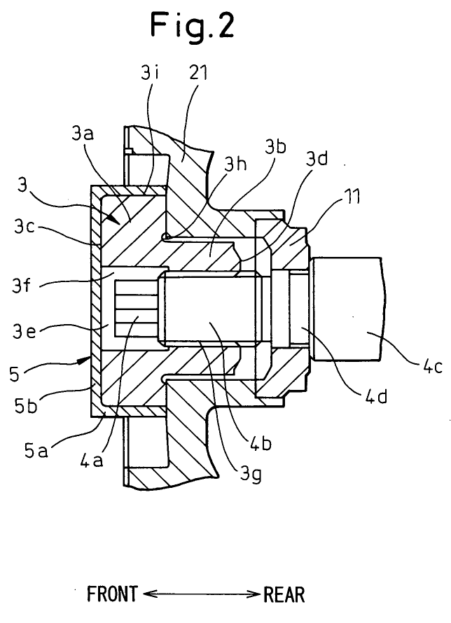

The embodiments of the invention are described below with reference to FIGS. 1 and 2. The power transmission apparatus is suitably used in a form assembled on the compressor of an automotive air conditioning system, and though assumed to be so assembled in the description that follows, may appropriately be used also for the rotary devices other than the compressor. FIG. 1 is a longitudinal sectional view of the power transmission apparatus according to an embodiment of the invention, and FIG. 2 an enlarged view of the essential parts shown in FIG. 1.

The power transmission apparatus according to this invention includes a rotary unit 10 rotated by the drive force from a rotation drive source such as an engine or an electric motor and a nut member 3 for coupling the rotary unit 10 to the rotary shaft 4 of the compressor to transmit the turning effort from the rotation drive source to the compressor. According to this embodiment, the rotary unit 10 consists of a belt pulley 1 providing a driving-side rotary unit and a hub 2 providing a driven-side rotary unit coupled to the belt pulley 1 in concavo-convex fashion and fixed on the rotary shaft 4 of the compressor. The nut member 3 is configured as a power shut-off member adapted to be broken by an excessively large torque to protect the belt, etc. The power transmission apparatus according to this invention further includes a cap member 5 mounted on the front side of the nut member 3. The belt pulley 1, the hub 2 and the nut member 3 are arranged on the same axis. The power transmission apparatus according to an embodiment of the invention will be explained in more detail below.

As shown in FIG. 1, according to this embodiment, the belt pulley 1 includes a rim portion 1a with a belt (not shown) suspended on the outer peripheral portion thereof for receiving the power, an annular rib portion 1b extending axially in a ring form to hold the bearing 6 and improve the rigidity of the belt pulley 1, a discal portion 1c for coupling the rim portion 1a and the annular rib portion 1b to each other and a pulley-side engaging portion 1d formed on the inner peripheral surface of the rim portion 1a on the front side of the discal portion 1c. The belt pulley portion 1 is rotatably mounted on a boss 7a formed at the first end of the casing 7 of the compressor, through a bearing 6 and a snap ring with sleeve ring 8. The belt pulley 1 is preferably formed of a thermosetting synthetic resin. Normally, the belt pulley 1, the snap ring with sleeve ring 8 and the bearing 6 are integrated with each other by insert molding. A belt (not shown) is wound on the outer peripheral surface of the rim portion 1a of the belt pulley 1, which in turn is rotated by an external power supply such as an engine or an electric motor. The movement of the bearing 6 in axial direction is blocked by the snap ring with sleeve ring 8 fitted in the groove formed on the outer peripheral surface of the boss 7a, an end portion of the boss 7a and a ring member 9 fitted in the snap ring with sleeve ring 8. The casing 7 and the rotary shaft 4 are hermetically sealed by a shaft-seal unit thereby to prevent the refrigerant and the oil from leaking outside. The shaft-seal unit is also prevented from moving in the axial direction by another snap ring fitted in the groove formed on the inner peripheral surface of the boss 7a.

The rotary shaft 4 of the compressor is projected to the front side in FIG. 2 from the casing 7, and includes, in the order from the forward end thereof, a forward end portion 4a comparatively small in diameter, an externally threaded portion 4b formed as a male screw on the outer periphery thereof, an intermediate shaft portion 4d lacking the thread ridge and a large-diameter shaft portion 4c largest in diameter. A washer 11 is inserted into the intermediate shaft portion 4d and held between the rear surface of the hub 2 and the stepped portion formed between the intermediate shaft portion 4d and the large-diameter shaft portion 4c.

Next, the hub 2 will be explained. The hub 2, as shown in FIG. 1, includes an inner hub 21 fitted in contact with the washer 11, a cylindrical portion 22 of an elastic material, such as rubber bonded by such a means as an adhesive on the outer periphery of the inner hub 21, a cylindrical outer ring 23 arranged on the outer periphery of the cylindrical portion 22 and a hub-side engaging portion 24 formed on the outer periphery of the outer ring 23 and adapted to engage the pulley-side engaging portion 1d. The inner hub 21 has, at the center thereof, an insertion hole 21 into which the small-diameter shaft portion 3b, described later, of the nut member 3 is inserted. The front end surface of the inner hub 21 is formed with a circular depression 21d in which the large-diameter shaft portion 3a of the nut member 3 is seated.

The nut member 3, as shown in FIG. 2, is in a stepped form having the large-diameter shaft portion 3a and the small-diameter shaft portion 3b. According to this embodiment, the large-diameter shaft portion 3a has a cross section in the shape of regular hexagon, though not shown. The nut member 3 has a central hole 3e formed therethrough from the first end surface 3c to the second end surface 3d thereof. The central hole 3e has a front-side non-threaded portion 3f and a rear-side internally threaded portion 3g. An annular notch 3h constituting a fragile portion is formed in the boundary portion between the large-diameter shaft portion 3a and the small-diameter shaft portion 3b. This annular notch portion 3h is formed to break under the axial force based on an excessive torque which may be exerted on the nut member 3. The cross section of the large-diameter shaft portion 3a, though in the shape of a regular hexagon according to this embodiment as described above, may alternatively assume any of various shapes such as a regular polygon, a polygon and a circle.

The internally threaded portion 3g of the nut member 3 is forced onto the externally threaded portion 4b of the rotary shaft 4 from the second end side. Then, the inner hub 21 is fastened between the large-diameter shaft portion 3a of the nut member 3 and the front end surface of the washer 11 and thus indirectly fixed on the rotary shaft 4, with the result that the hub 2 and the belt pulley 1 engaged therewith are coupled to and integrally rotated with the rotary shaft 4. The power transmission apparatus according to this embodiment is configured as described above, and therefore the turning effort received by the belt pulley 1 from the belt can be transmitted to the rotary shaft 4 through the hub 2 and the nut member 3.

Before forcing the nut member 3 onto the rotary shaft 4, the grease or oil is normally coated on the internally threaded portion 3g and the externally threaded portion 4b. By coating the grease or oil in this manner, the friction coefficient of the threaded portions 3g, 4b is reduced and stabilized, thereby making it possible to suppress the variations of the torque for breaking the annular notch 3h.

According to this embodiment, the cap member 5 is formed of an anti-corrosive synthetic resin material having an outer peripheral wall portion 5a extending in axial direction and a bottom surface portion 5b for closing the first end of the space defined by the outer peripheral wall portion 5a. The cap 5 has a cross section in the shape corresponding to the cross section of the large-diameter shaft portion 3a of the nut member 3 capped with the cap member 5, that is, a regular hexagon according to this embodiment. The hexagon formed by the outer peripheral wall portion 5a is slightly smaller than the regular hexagon of the nut member 3, and the inside dimension of the axial height of the outer peripheral wall portion 5a is substantially equal to the axial size of the large-diameter shaft portion 3a of the nut member 3. The cap 5, though slightly smaller in diametrical size than the nut member 3, can be capped onto the nut member 3 in such a manner as to cover the first end surface 3c on the front side of the nut member 3 and the outer peripheral surface 3i of the large-diameter portion 3a by elastic deformation.

The outer wall portion 5a of the cap 5 and the outer peripheral surface 3i of the large-diameter shaft portion 3a of the nut member 3 receive the pressure exerted on each other due to the elastic deformation of the cap 5. Thus, the seal portion is formed to seal the inner peripheral portion thereof, thereby sealing also the screwed portion between the internally threaded portion 3g and the externally threaded portion 3a. The cap member 5 covers the first end surface 3c of the nut member 3 and the outer peripheral surface 3i of the large-diameter shaft portion 3a, i.e., the externally exposed portion of the nut member 3, and therefore the appearance is not deteriorated by the corrosion even without the surface treatment such as plating of the cap member 5 formed of, for example, a steel material.

The cap 5 may be formed of a rubber material or a metal material such as stainless steel or aluminum comparatively high in corrosion resistance. The cap 5, if formed of a metal material, is capped by press fitting on the nut member 3.

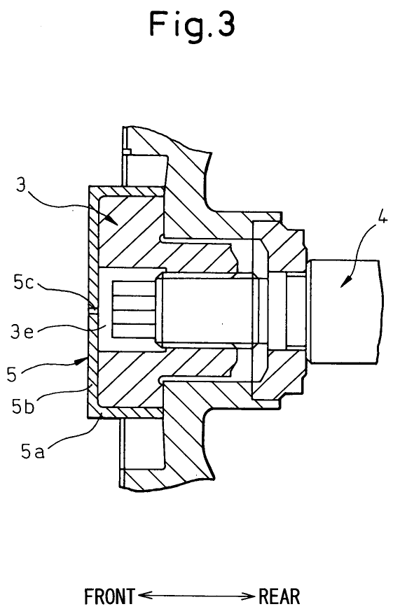

Next, a modification of the embodiment described above will be explained with reference to FIG. 3 showing the longitudinal sectional view of the essential parts thereof. The power transmission apparatus shown in FIG. 3 has a cap 5 different from the cap shown in FIGS. 1 and 2 in the small hole 5c formed at the center of the bottom surface portion 5b. The small hole 5c is formed as a vent to prevent the cap member 5 from coming off of the nut member 3 with the increase in the internal pressure of the space of the central hole 3c of the nut member which in turn is caused by the temperature increase while the vehicle is driven. The small hole 5 is preferably as small as possible to minimize the air permeability range to maintain the waterproofness, and therefore the labyrinth structure may be employed as a preferred example.

While the invention has been described by reference to specific embodiments chosen for purposes of illustration, it should be apparent that numerous modifications could be made thereto by those skilled in the art without departing from the basic concept and scope of the invention.

1. A power transmission apparatus comprising:
a rotary unit rotated by the turning effort received from a rotation drive source; and
a nut member for coupling the rotary unit to a rotary shaft of a driven-side rotary device for transmitting the turning effort from the rotation drive source to the rotary device;
wherein the nut member includes a central hole formed through from a first end surface to a second end surface of the nut member and an internally threaded portion formed in the central hole; and
wherein the rotary unit is coupled to the rotary shaft by forcing the internally threaded portion onto an externally threaded portion formed on the rotary shaft from the second end surface side;
the power transmission apparatus further comprising a cap capped onto the nut member in such a manner as to cover and seal the first end surface of the nut member and an outer peripheral surface of the nut member connecting to the peripheral edge of the first end surface.

2. The power transmission apparatus according to claim 1, wherein the cap is formed of an anti-corrosive material.

3. The power transmission apparatus according to claim 2, wherein the cap is formed of a synthetic resin material.

4. The power transmission apparatus according to claim 2, wherein the cap is formed of a rubber material.

5. The power transmission apparatus according to claim 1,
wherein the cap includes an outer peripheral wall portion extending in axial direction and a bottom surface portion extending in radial direction in such a manner as to close a first end side of a space defined by the outer peripheral wall portion, and
wherein the bottom surface portion has a small hole as a vent.

6. The power transmission apparatus according to claim 1, wherein the nut member is a power shut-off member having a fragile portion adapted to break under an excessively large torque exceeding a predetermined torque exerted on the nut member.

7. The power transmission apparatus according to claim 1, wherein the rotary unit includes a belt pulley and a hub coupled to the inner periphery of the belt pulley.

8. A power transmission apparatus for transmitting the turning effort from a rotation drive source to the rotary shaft of a driven-side rotary device, comprising:
a rotary unit adapted to rotate by the turning effort received from the rotation drive source;
a nut member for coupling the rotary unit to the rotary shaft by being screwed to the rotary shaft; and
a cap mounted on the nut member in such a manner as to cover and seal the surface of the portion of the nut member exposed externally of the power transmission apparatus when the nut member is screwed to the rotary shaft to couple the rotary unit to the rotary shaft.
